(19) United States
(12) Patent Application Publication
(10) Pub. No.: US 2016/0073771 A1
(43) Pub. Date: Mar. 17, 2016

(54) TOOTHBRUSH WITH DENTAL PLAGUE DISPLAY FUNCTION

(71) Applicant: Yung-Wei SHIH, Hsinchu City (TW)

(72) Inventor: Yung-Wei SHIH, Hsinchu City (TW)

(21) Appl. No.: 14/855,862

(22) Filed: Sep. 16, 2015

(30) Foreign Application Priority Data
Sep. 17, 2014 (TW) 103132009

(51) Int. Cl. A46B 15/00; A61C 17/34; A46B 17/08; A46B 5/00

(52) U.S. Cl. CPC A46B 15/0036; A46B 5/0095; A61C 17/34; A46B 17/08

(57) ABSTRACT

The present invention relates to a toothbrush with dental plague display function. The toothbrush includes a toothbrush head, a toothbrush handle, a filter lens, a power device, an LED and a control circuit. Through the control circuit and the power device, the LED generates ultraviolet light that is radiated upon surfaces of teeth. The ultraviolet light is reflected by a mirror, and excessively reflected ultraviolet light on the surfaces of teeth is removed by the exclusive filter lens, and a user is allowed to easily observe dental plague displaying a fluorescence reaction on the surfaces of teeth.

### BACKGROUND OF THE INVENTION

a) Field of the Invention

The invention relates in general to a toothbrush with a dental plague display function, and more particular to a toothbrush disposed with a light emitting diode (LED) having a predetermined wavelength to provide the toothbrush with a dental plague display function.

b) Description of the Prior Art

Oral hygiene closely affects interpersonal relationships and is also a common life etiquette. People generally achieve oral cleaning by using toothbrushes, floss and mouthwash.

A conventional manual toothbrush or electric toothbrush provides people with only a function of cleaning dental plague, and is incapable of effectively learning the condition of dental plague removal. In view of oral hygiene highly valued by people, the present invention improves conventional manual toothbrushes or electric toothbrushes that provide only a function of dental plague removal to satisfy the inventive step for an invention.

Therefore, the present invention provides a toothbrush with a dental plague display function for solving the above issues of conventional manual toothbrushes or electric toothbrushes.

### SUMMARY OF THE INVENTION

To achieve the above object, the present invention provides a toothbrush including an light emitting diode (LED). The LED is disposed in the toothbrush, and is a light source for generating an ultraviolet wavelength. By radiating surfaces of teeth with ultraviolet light, a fluorescence reaction is generated by dental plague on the surfaces, and the condition of dental plague removal can then be learned.

According to the above object, the present invention is a structure applicable to a common toothbrush or an electric toothbrush. The structure of the present invention includes a toothbrush handle internally provided with a battery and a circuit board. The battery provides the toothbrush with electric power. The circuit board is a control circuit, and is electrically connected to an LED. The LED is provided below a toothbrush head.

The toothbrush handle is provided with a control switch at an exterior thereof. The control switch is electrically connected to the control circuit. A user may operate the control switch to drive the control circuit, such that the LED receives a corresponding control signal transmitted by the control circuit and radiates light having an ultraviolet wavelength upon surfaces of teeth. Dental plague on the surfaces of teeth absorbs the ultraviolet light and displays a fluorescence reaction. Through a filter lens disposed at a rear of a toothbrush neck, excessive ultraviolet light reflected by the surfaces of teeth is filtered to allow the user to easily observe dental plague displaying the fluorescence reaction at the surfaces of teeth through a mirror and to further learn the condition of dental plague removal. The present invention is a device providing both usefulness and inventive step.

According to the foregoing main characteristics, the toothbrush head and the toothbrush handle are structures that can be assembled with and detached from each other.

According to the foregoing main characteristics, the LED is disposed at a position at a bottom portion of the toothbrush head and/or between the toothbrush head and the toothbrush handle.

According to the foregoing main characteristics, the LED is a light emitting having a light emitting wavelength that is an ultraviolet light wavelength between 300 nm and 400 nm.

According to the foregoing main characteristics, an appearance of the LED may be a rounded top shape, a square, or a surface mount shape. Further, the LED may be fixed to any part of the toothbrush head or toothbrush handle through a specially designed base, and may be packaged at any part of the toothbrush head or toothbrush handle through a material such as epoxy.

According to the foregoing main characteristics, for example but not limited to, the toothbrush may be a common toothbrush or an electric toothbrush.

According to the foregoing main characteristics, the filter lens is a lens capable of filtering a wavelength that is an ultraviolet light wavelength between 300 nm and 400 nm. Thus, the color of the filter lens may be yellow and/or yellow-brown and/or orange and/or red and/or brown.

According to the foregoing main characteristics, the present invention further comprises a heating dissipating element disposed at the toothbrush head and/or toothbrush handle.

### BRIEF DESCRIPTION OF THE DRAWINGS

FIG. 1 is a section view of a toothbrush with a dental plague display function of the present invention;

FIG. 2 is a front view of a toothbrush with a dental plague display function of the present invention, showing an LED disposed between a toothbrush head and a toothbrush handle;

FIG. 3 is a rear view of a toothbrush with a dental plague display function of the present invention, showing a filter lens disposed between a toothbrush head and a toothbrush handle; and

FIG. 4 is an exploded view of a toothbrush with a dental plague display function of the present invention, showing a toothbrush head, a toothbrush handle and a filter lens that can be assembled with and detached from one another.

### DETAILED DESCRIPTION OF THE PREFERRED EMBODIMENTS

The above and other aspects of the invention will become better understood with regard to the following detailed description of the preferred but non-limiting embodiments. The following description is made with reference to the accompanying drawings.

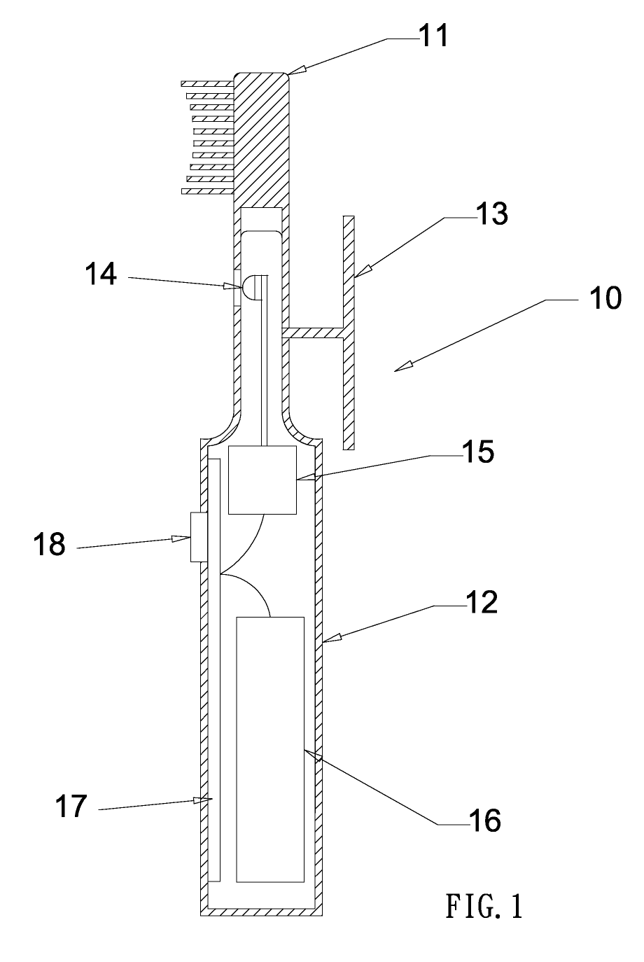

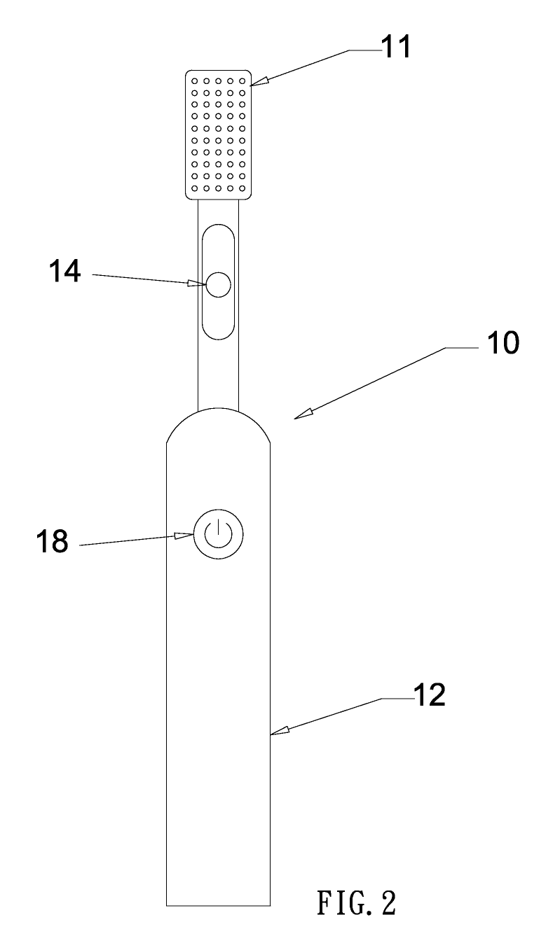

Referring to FIG. 1 and FIG. 2, the present invention includes a toothbrush 10, a toothbrush head 11, a toothbrush handle 12, a filter lens 13, a light emitting diode (LED) 14, a heat dissipating element 15, a battery 16, a circuit board 17 and a control switch 18. The toothbrush 10 of the present invention is not limited to an electric toothbrush or a common toothbrush, and is a cleaning utensil mainly serving a purpose of tooth cleaning. In general, the foregoing toothbrush 10 at least includes the toothbrush head 11, the toothbrush handle 12 and the filter lens 13.

The toothbrush handle 12 of the present invention internally includes the heat dissipating element 15, the battery 16, and the circuit board 17 including a control circuit. The heat dissipating element 15 is disposed at the toothbrush head 11 or the toothbrush handle 12, or may be simultaneously disposed at both the toothbrush head 11 and the toothbrush handle 12. The circuit board 17 is electrically connected to the LED 14 and the battery 16, and is provided with the control switch 18 thereon. A user operates the control switch 18 to drive the control circuit on the circuit board 17 to further cause the LED 14 receive a control signal transmitted by the control circuit. Thus, while the user brushes teeth, ultraviolet light having a wavelength between 300 nm and 400 nm is radiated upon surfaces of the user's teeth and is absorbed by dental plague on the surfaces of teeth to induce fluorescent reflected light. The user may then easily observe the existence of dental plague through a mirror.

In the present invention, the LED 14 is a light emitting having a light emitting wavelength that is an ultraviolet light wavelength between 300 nm and 400 nm, and is mainly disposed at a bottom portion of the toothbrush head 11 or between the toothbrush head 11 and the toothbrush handle 12. An appearance of the LED 14 may by a rounded top shape, a square or a surface mount shape. Alternatively, the LED 14 may be fixed at a position at the toothbrush head 11 or the toothbrush handle 12 (as shown in FIG. 2) through a specially designed base (not shown in drawings). The LED 14 of the present invention may be packaged at a position of the toothbrush head 11 or the toothbrush handle 12 through a material such as epoxy.

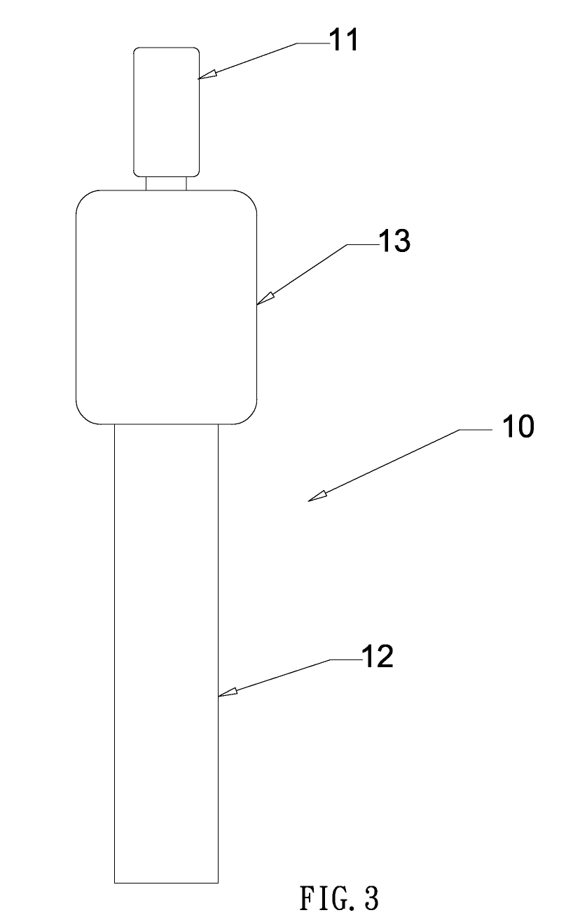

Referring to FIG. 3, the toothbrush 10 of the present invention further includes at least one filter lens 13 at a rear and between the toothbrush head 11 and the toothbrush handle 12 (as shown in FIG. 3). The filter lens 13 may be a lens capable of filtering a wavelength that is an ultraviolet light wavelength between 300 nm and 400 nm, and the color of the filter lens may be yellow and/or yellow-brown and/or orange and/or red and/or brown. Thus, the user is allowed to easily identify dental plague displaying a fluorescence reaction at the surfaces of teeth to solve an issue that an intense reflection is generated at the surfaces of teeth by non-ultraviolet radiation, thereby achieving a toothbrush having a dental plague display function.

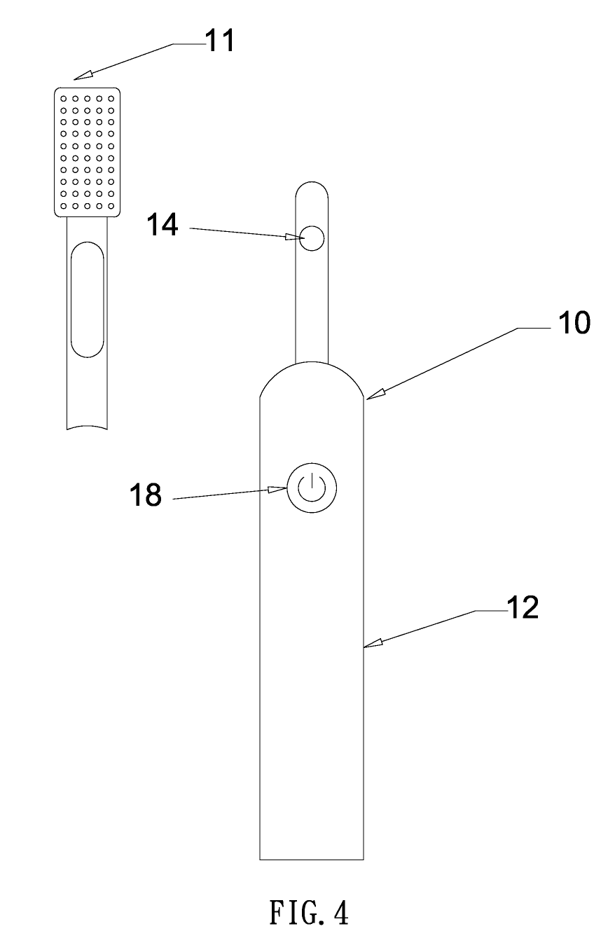

Referring to FIG. 4, the toothbrush 10 of the present invention may be designed as a detachable structure. That is, the toothbrush may be disassembled into the toothbrush head 11, the toothbrush handle 12 and the filter lens 13 (as shown in FIG. 1), which may be assembled with or detached from one another. The LED 14 is disposed in the toothbrush handle 12. As such, the toothbrush head 11 may be detached and replaced to meet hygiene requirements after a period of use.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A toothbrush having a dental plague display function, comprising:
a toothbrush head;
a toothbrush handle;
at least one light emitting diode (LED), disposed within the toothbrush structure, capable of emitting light with a predetermined wavelength;
a battery, disposed within the toothbrush structure, providing the LED with power;
a circuit board, disposed in the toothbrush structure, for controlling turning on and turning off the LED;
a heat dissipating element, disposed within the toothbrush structure, providing the LED with a heat dissipating effect; and
a filter lens, disposed outside the toothbrush structure, for filtering out excessively reflected ultraviolet light.

2. The toothbrush having a dental plague display function of claim 1, wherein the toothbrush head and the toothbrush handle that can be detached from and assembled with each other.

3. The toothbrush having a dental plague display function of claim 1, wherein the LED is disposed at the toothbrush head or between the toothbrush head and the toothbrush handle.

4. The toothbrush having a dental plague display function of claim 3, wherein the LED is a light emitting having light emitting wavelength that is an ultraviolet light wavelength between 300 nm and 400 nm.

5. The toothbrush having a dental plague display function of claim 4, wherein a shape of the LED is a rounded top shape, a square or a surface mount shape; or the LED is fixed at a part of the toothbrush head or the toothbrush handle through a specially designed base, and is packaged to the part of the toothbrush head or the toothbrush handle through a material like epoxy when the toothbrush is manufactured.

6. The toothbrush having a dental plague display function of claim 1, wherein the toothbrush is a common toothbrush or an electric toothbrush.

7. The toothbrush having a dental plague display function of claim 1, wherein the filter lens is a lens capable of filtering a wavelength between 300 nm and 400 nm.

8. The toothbrush having a dental plague display function of claim 1, wherein a color of the filter lens is yellow, yellow-brown, orange, red or brown.

9. The toothbrush having a dental plague display function of claim 1, wherein the heat dissipating element is disposed at the toothbrush head or the toothbrush handle, or is simultaneously disposed at the toothbrush head or the toothbrush handle.
